(19) United States
(12) Patent Application Publication
(10) Pub. No.: US 2005/0042922 A1
(43) Pub. Date: Feb. 24, 2005

(54) Plug connector with electrically conductive plastic cap

(75) Inventors: Wolfgang Haller, Schwaikheim (DE); Uwe Widmann, Baltmannsweiler (DE)

Correspondence Address: THE FIRM OF KARL F ROSS, 5676 RIVERDALE AVENUE, PO BOX 900, RIVERDALE (BRONX), NY, 10471-0900, US

(73) Assignee: Hirschmann Electronics GmbH & Co. KG

(21) Appl. No.: 10/923,601

(22) Filed: Aug. 20, 2004

(30) Foreign Application Priority Data
Aug. 22, 2003 (DE) 10338616.5

(51) Int. Cl. H01R 13/648

(52) U.S. Cl. 439/607

(57) ABSTRACT

A plug and jack connection can have a housing which is electrically conductive, e.g. by the incorporation of conductive particles in a synthetic resin from which the housing is molded, electrically connected with a cable shield, so that upon connection of the plug and jack, there will be continuity of shielding across the connector.

### FIELD OF THE INVENTION

Our present invention relates to a plug connection, and particularly a connector which can be a plug or jack of a shielded plug connection.

### BACKGROUND OF THE INVENTION

Plug or jacks for plug connections generally comprise an insulated housing which can surround contact elements forming contact partners when one is inserted into the other. These contact partners may be contact pins and contact sleeves adapted to receive the pins. The contact partners are provided in an appropriate number and configuration, depending upon the layout desired for a single conductor or multiconductor cable.

Generally, the conductors of the cable are affixed to the contacts by soldering, as an example of a permanent connection, or by some other attachment arrangement, e.g. insulation-cutting contacts, clamping-screw contacts or the like as examples of a detachable connection.

Depending upon the particular applications, it may be important for the cable and the assembled plug connection to be shielded, and in that case, the plug connection should provide continuity of shielding extending the shielding of the cable, which usually has a braided conductor forming the shield around the main conductors of the cable. The shielding can be connected to ground and serves to prevent noise and other perturbation signals from reaching the internal conductors.

### OBJECTS OF THE INVENTION

It is the principal object of the present invention to provide an improved shielding of a plug connector.

Another object is to provide a plug and jack connection which can extend the shielding afforded by a shielded cable and thereby protect internal conductors against noise and perturbations signals in a simple and economical manner.

### SUMMARY OF THE INVENTION

These objects are achieved, in accordance with the invention with a connector in the form of a plug or jack or a shielded plug connection which comprises:
a cable having a shield and at least one conductor surrounded by the shield;
a housing composed of an electrically conductive synthetic resin electrically connected with the shield;
at least one conductor in the housing, electrically connected with the conductor and insulated from the housing.

The electrically-conductive outer housing of the plug or jack, which bears upon and thus is electrically connected to the cable shield ensures continuity of shielding through the plug connection once the plug is assembled with the jack.

The housing can be a separate member which is applied to the cable, e.g. can be clamped thereon or can form a permanent connection therewith via, for example, an electrically conductive adhesive or by being injection molded onto the cable and the internal elements of the plug and jack, such as the contact which can previously be attached to the cable. The use of an electrically-conductive housing has a significant advantage since it permits axial shifting of the housing and its insertion into an apparatus to be connected with the shielded cable to maintain continuity of the shielding around the cable to the housing.

The housing can be composed of a plastic which normally has electrically-insulating properties but into which conductive particles, for example graphite or carbon black, have been incorporated or a plastic which is provided with a conductive coating.

The material pairing, e.g. synthetic resin and carbon black particles, allows a plastic to be selected which has the requisite insulation characteristics where insulation is maintained, and electrically-conductive particles to be incorporated where the continuity of the shielding is to be maintained from plug to jack or jack to plug after assembly of the connection. This applies also where the plug is to be inserted into a casing of a unit containing an electrical circuit.

When a coating is applied, the coating can be provided on the interior of the housing and can make electrical contact with a conductive housing of the other part.

The fabrication of the housing can be effected in different ways. For example, the housing can be made by injection molding, in which case the particles are mixed with the synthetic resin before injection. If the housing is injection molded as a unit, it can be slid over the other components of the plug or jack after they have been mounted on the cable. Alternatively the housing can be injection molded on to the cable. Insulation between the conductors and the housing can utilize sealing compositions, preformed members or the like.

Before injection molding of the housing onto the cable, the cable shield is exposed to ensure a good electrical connection therewith by the electrically conductive housing.

If desired, the housing can be externally coated with an insulating material to prevent short-circuiting of other circuits by the housing.

### BRIEF DESCRIPTION OF THE DRAWING

The above and other objects, features, and advantages will become more readily apparent from the following description, reference being made to the accompanying drawing in which:

FIG. 1 is a side elevational view of a plug connector illustrating the invention;

FIG. 2 is a cross sectional view taken along the line II-II of FIG. 1;

FIG. 3 is a fragmentary section of a jack forming part of a plug connection in accordance with the invention; and

FIG. 4 is a cross sectional view illustrating a feature of the invention.

### SPECIFIC DESCRIPTION

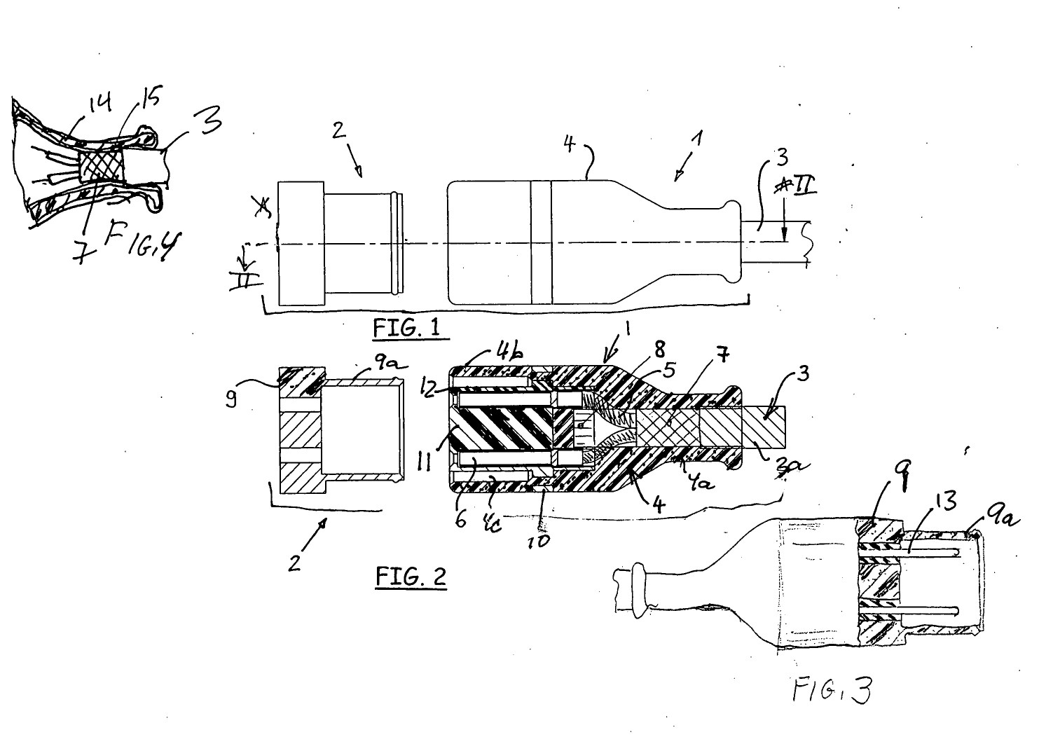

FIG. 1 is an elevational view of a plug 1 and a corresponding jack 2 which together can form a plug connection in accordance with the present invention. Internal structures of the plug and jack can be deduced from FIG. 2 and will, of course, depend upon the particular requirements. This can include the number of connections with which the plug connection is to be made, i.e. the number of contact partners in the plug and jack, respectively. For example, the plug can have a plurality of conductive sleeves 6, each of which can have, as a contact partner, a pin of the jack 2. Alternatively, the contacts on the plug may be pins and the contact partners thereof, on the jack 2 may be sleeves. What is important to the invention is that after the assembly of the plug and the jack together, i.e. the insertion of one into the other, a continuous shielding is provided so that undesired passage through the plug to the contact partner of noise or other detrimental signals can be avoided.

More particularly, at an end of a cable 3, the plug 1 can be so arranged that the internal conductors 5 of the cable 3 are soldered, clamped or otherwise joined to the contacts 6 of the plug. The contacts 6 are here shown as sleeves but can be pins as has been noted. The configuration, arrangement and number of contacts to which the ends of the conductors 5 are connected can be selected optionally and are, of course, matched with those of the jack to satisfy the particular purpose when the plug and jack are inserted one into the other. The particular orientations and numbers of contacts, however, are not significant to the invention.

To obtain the continuous shielding from the cable 3 through the plug connector of the invention, the cable 3 has the usual braided shield 7 surrounding the conductors 5. This shield is usually grounded and prevents external noise or interfering signals from passing through the cable 3 to the conductors 5. According to the invention, an external housing 4 of the plug surrounds the end at which the cable terminates and has a neck 4a which hugs and makes electrical contact with the shield 7 where it is exposed by stripping back of the insulation 3a of the cable. At the end facing the jack, the housing 4 can be a cup-shaped portion 4b with a cavity 4c accommodating the cup-shaped portion 9a of the jack 2. The housing 4 in the region of the braided shield 7 is such that good electrical contact is provided between them. The connection of the housing 4 to the cable 3 can be permanent or detachable. The insulation of the contact 6 from the housing 4 can be accomplished by insulating potting compounds 11 and/or insulating sleeves 12 or spacers 8 of hard or elastic material and which can be applied to the contacts before the housing 4 is slid or molded over them. The jack 2 can be composed of an electrically-conductive metal body or an electrically-conductive plastic and will normally have contact partners for the sleeves 6.

In FIG. 3, the contact pins 13 are shown to be insulated from the conductive member 9 for the jack. The plug can serve to connect electronic components or appliances of all types with cable, including actuators and sensors and nevertheless ensure a continuous shielding. The conductive plastic can be formed by incorporating graphite particles in any plastic conveniently used as a plug or jack housing.

In FIG. 4 a synthetic resin housing 14 is shown which has a layer or coating 15 of conductive material which contacts the shield 7 of the cable 3 plug connector with an electrically-conductive plastic cap.

1. A connector in a form of a plug or jack for a shielded plug connection comprising:
a cable having a shield and at least one conductor surrounded by said shield;
a housing composed of an electrically conductive synthetic resin electrically connected with said shield;
at least one conductor in said housing, electrically connected with said conductor and insulated from said housing.

2. The connector defined in claim 1 wherein said housing is composed of a synthetic resin having electrically conductive particles distributed therein.

3. The connector defined in claim 1 wherein said housing is composed of a synthetic resin having an electrically conductive coating electrically connected to said shield.

4. The connector defined in claim 1 wherein said housing is formed as a separate element adapted to be mounted on said cable.

5. The connector defined in claim 1 wherein said housing is injection molded onto said cable and around internal elements of the connector previously provided on the cable.
